(19) United States
(12) Patent Application Publication
(10) Pub. No.: US 2013/0201157 A1
(43) Pub. Date: Aug. 8, 2013

(54) USER INTERFACE DEVICE AND METHOD OF PROVIDING USER INTERFACE

(71) Applicant: Samsung Electro-Mechanics Co., Ltd., Gyeonggi-do (KR)

(72) Inventor: Il Kwon Chung, Gyeonggi-do (KR)

(73) Assignee: SAMSUNG ELECTRO-MECHANICS CO., LTD., Gyeonggi-do (KR)

(21) Appl. No.: 13/744,181

(22) Filed: Jan. 17, 2013

(30) Foreign Application Priority Data
Jan. 19, 2012 (KR) 10-2012-0005981

(51) Int. Cl. G06F 3/042

(52) U.S. Cl. CPC G06F 3/042
USPC 345/175

(57) ABSTRACT

Provided is a user interface device and a method of providing a user interface. The user interface device includes a motion detection unit, and a control unit configured to perform an operation corresponding to the motion pattern of the input unit, wherein the motion detection unit includes a plurality of camera modules installed around both sides of the display unit to photograph the input unit, a position determination unit configured to calculate position coordinate values, at which the input unit is disposed on the virtual input space, from an image of the input unit obtained by the respective camera modules, and a motion pattern determination unit configured to detect the motion pattern of the input unit based on the position coordinate values. Therefore, a user can more comfortably and intuitively control an electronic instrument system.

### CROSS-REFERENCE TO RELATED APPLICATIONS

This application claims the benefit of Korean Patent Application No. 10-2012-0005981 filed with the Korea Intellectual Property Office on Jan. 19, 2012, the disclosure of which is incorporated herein by reference.

### BACKGROUND OF THE INVENTION

1. Field of the Invention

The present invention relates to a user interface device and a method of providing a user interface, and more particularly, to a user interface device for an electronic instrument as a means for inputting information in the electronic instrument or controlling a system, and method of providing a user interface.

2. Description of the Related Art

In recent times, electronic instruments are widely used in daily life. Mobile phones as well as PCs used in home and office are provided. In particular, in recent times, as functions are diversified, mobile terminals such as mobile phones are implemented as multimedia players having complex functions such as photographing photographs or videos, playing music, video files or games, receiving broadcasts, and so on.

A user interface (UI) is a physical and virtual medium provided to perform temporary or permanent access for communication between a user and an electronic instrument. Such an user interface functions as an input means for allowing the user to manipulate a system of the electronic instrument or providing information, and an output means for displaying a result used by the user through the system of the electronic instrument.

The user interface may include a text user interface (TUI), which is a character-based interface, a graphic user interface (GUI) formed of graphics and texts corresponding to systematic elements, a sound user interface, or the like.

However, as described above, as the electronic instrument performs complex functions, demands for simpler, intuitive and multi-functional user interfaces are being increased as time elapses.

Input methods in computer environments use various pointers such as a mouse, a track ball, and various touch-detection pads, from button keys of a standard keyboard. In particular, in recent times, as smart phones are released, user interfaces using touch screens are widely used. When a finger touches the touch screen, movement of the finger is detected by the touch screen to perform various operations. However, the touch screen can exhibit functions thereof through touch only but cannot exhibit the functions of the user interface when a hand is disposed at a position spaced apart from the screen or deviated from a region of the screen.

### SUMMARY OF THE INVENTION

The present invention has been invented in order to overcome the above-described problems and it is, therefore, an object of the present invention to provide a user interface device and method of providing a user interface including a plurality of camera modules and configured to detect a motion of an input unit, which is an input means of the user interface, to perform functions of the interface.

In accordance with one aspect of the present invention to achieve the object, there is provided a user interface device including: a motion detection unit configured to detect a motion pattern of an input unit that moves on a virtual input space formed around an electronic instrument main body including a display unit; and a control unit configured to perform an operation corresponding to the motion pattern of the input unit, wherein the motion detection unit includes: a plurality of camera modules installed around both sides of the display unit to photograph the input unit; a position determination unit configured to calculate position coordinate values, at which the input unit is disposed on the virtual input space, from an image of the input unit obtained by the respective camera modules; and a motion pattern determination unit configured to detect the motion pattern of the input unit based on the position coordinate values.

In addition, in the user interface device, the virtual input space may be formed at an upper space of the display unit or left and right spaces of the upper space according to a viewing angle that can be obtained by the camera modules.

Further, in the user interface device, each of the camera modules may include a wide-angle lens having a viewing angle of 360 degrees; an image sensor configured to convert light received through the lens into an electrical video signal; and a communication interface in communication with the position determination unit.

Furthermore, in the user interface device, the number of camera modules may be two.

In addition, in the user interface device, the two camera modules may be disposed on the same line along an edge of the display unit.

Further, in the user interface device, the position determination unit may obtain a vertical point P′, at which the input unit disposed at one position on the virtual input space is perpendicular to a plane of the display unit, from the image of the input unit obtained by the camera modules; calculate an angle a formed by a straight line connecting the two camera modules and a straight line connecting a first camera module of the two camera modules and the vertical point P′, calculate an angle b formed by a straight line connecting the two camera modules and a straight line connecting a second camera module of the two camera modules and the vertical point P′, and obtain x and y coordinate values of the input unit and a length of a straight line connecting the first camera module and the vertical point P′; and calculate an angle c formed by the input unit and the plane of the display unit to obtain a z coordinate value of the input unit.

Furthermore, in the user interface device, the motion pattern determination unit may receive the position coordinate values of the input unit from the position determination unit to detect the motion pattern.

In accordance with another aspect of the present invention to achieve the object, there is provided a method of providing a user interface including: photographing an input unit that moves on a virtual input space formed around an electronic instrument main body including a display unit using a plurality of camera modules; calculating position coordinate values at which the input unit is disposed on the virtual input space from an image of the input unit obtained by the respective camera modules; detecting a motion pattern of the input unit based on the position coordinate values; and performing an operation corresponding to the motion pattern of the input unit.

In addition the method of providing a user interface may further include, before photographing the input unit, forming the virtual input space in the display unit or a region deviated from the display unit according to a viewing angle that can be obtained by the camera modules.

Further, in the method of providing a user interface, photographing the input unit may perform a process of receiving light reflected by the input unit through a wide-angle lens having a viewing angle of 360 degrees and converting the received light into an electrical video signal.

Furthermore, in the method of providing a user interface, calculating the position coordinate values may include obtaining a vertical point P′ at which the input unit disposed at one position on the virtual input space is perpendicular to a plane of the display unit from an image of the input unit obtained by the camera modules; calculating an angle a formed by a straight line connecting the two camera modules and a straight line connecting a first camera module of the two camera modules and a vertical point P′, calculating an angle b formed by a straight line connecting the two camera modules and a straight line connecting a second camera module of the two camera modules and the vertical point P′, and obtaining x and y coordinate values of the input unit and a length of a straight line connecting the first camera module and the vertical point P′; and calculating an angle c formed by the input unit and a plane of the display unit to obtain a z coordinate value of the input unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing a schematic configuration of a user interface device according to the present invention;

FIG. 2 is a view showing appearance of an electronic instrument main body including the user interface device according to the present invention;

FIGS. 3A and 3B are views showing a virtual input space formed along the user interface device according to the present invention;

FIGS. 4A and 4B are explanatory views for understanding an operation performed in a position determination unit included in the user interface device according to the present invention; and

FIG. 5 is a flowchart sequentially showing a method of providing a user interface according to the present invention.

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

Hereinafter, configurations and effects of the present invention will be described in detail with reference to the accompanying drawings.

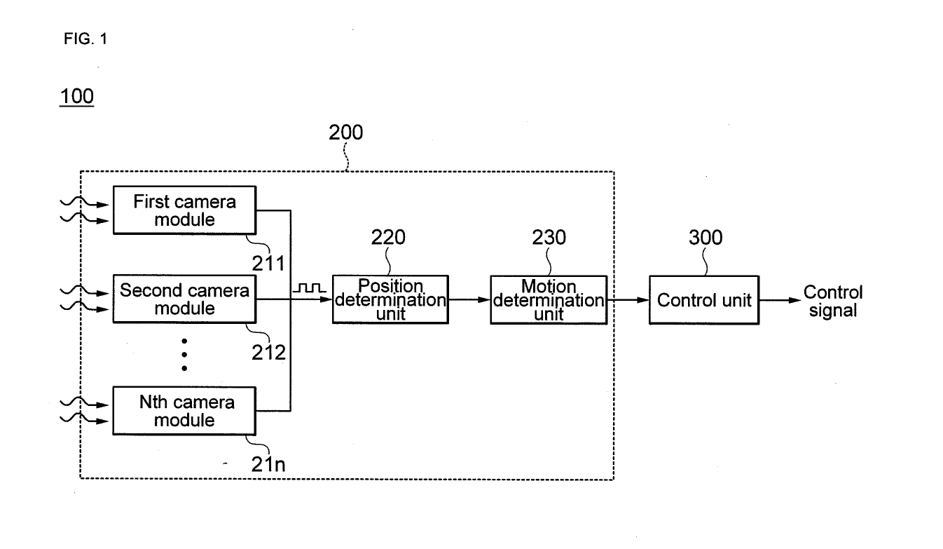

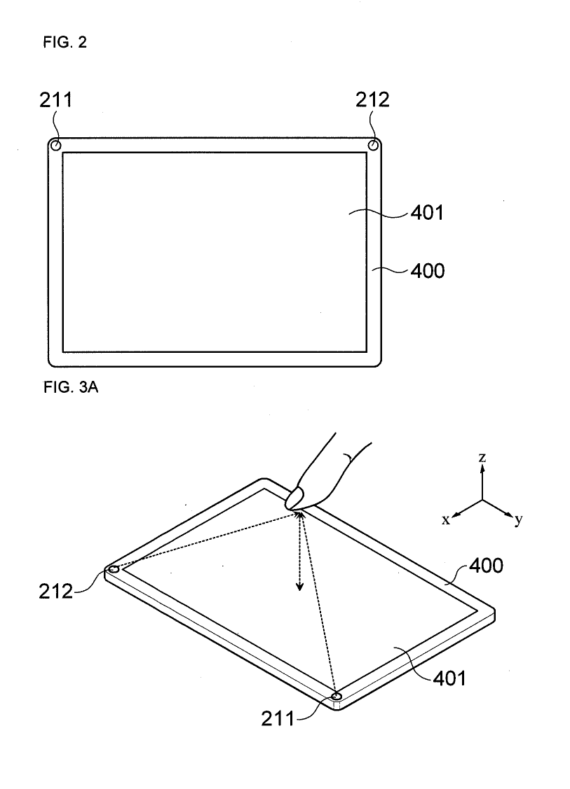

FIG. 1 is a block diagram showing a schematic configuration of a user interface device according to the present invention, and FIG. 2 is a view showing appearance of an electronic instrument main body including the user interface device according to the present invention.

Referring to FIGS. 1 and 2, a user interface device 100 according to the present invention includes a motion detection unit 200 and a control unit 300.

The motion detection unit 200 functions to detect a motion pattern of an input unit that moves on a virtual input space formed around an electronic instrument main body 400 including a display unit 401.

Here, the electronic instrument main body 400 may include a mobile phone, a smart phone, a laptop computer, a digital broadcasting terminal, personal digital assistants (PDA), a portable multimedia player (PMP), a navigation system, or the like.

In addition, the virtual input space means a space in which the input is performed to operate the system of the electronic instrument main body 400 including the user interface device 100 and provide information to the system.

Further, the input unit is a unit, which is an input unit directly moves on the virtual input space, and specifically, may be various objects such as a user's finger, a finger tip, a tip of a pen gripped by a user, or the like.

More specifically, referring to the motion detection unit 200, the motion detection unit 200 may include a plurality of camera modules 211, 211 and 21n, a position determination unit 220 and a motion pattern determination unit 230.

The plurality of camera modules 211, 211 and 21n are installed around both ends of the display unit 401 and can perform a function of photographing the input unit that moves on the virtual input space formed around the main body 400.

In particular, as shown in FIG. 2, each of the camera modules may be constituted by two cameras disposed on the same line around both ends of the display unit 401, respectively. Accordingly, a straight line connecting the two camera modules 211 and 212 may be parallel to an edge of an upper end of the display unit 401.

The camera modules 211, 211 and 21n may include lenses, image sensors and communication interfaces.

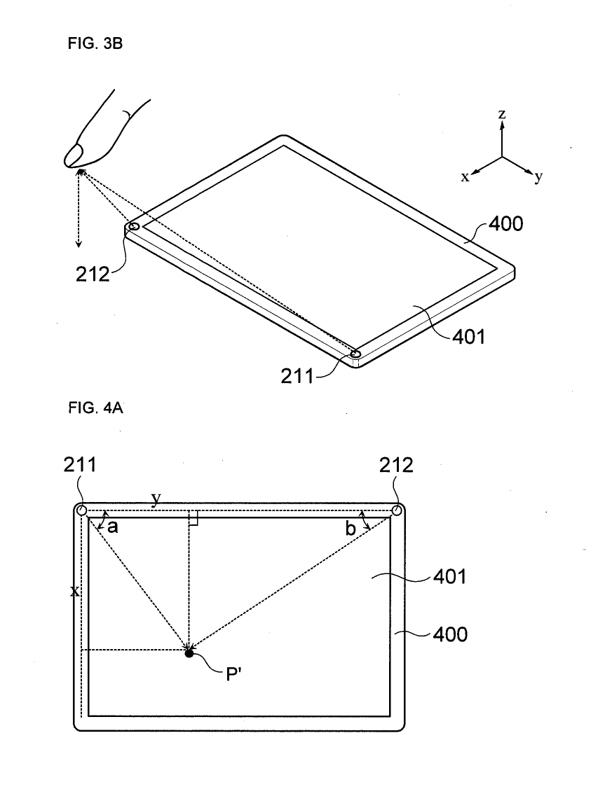

In particular, the lens may be constituted by a wide-angle lens having a viewing angle of 360 degrees. As described above, in the user interface device 100 according to the present invention, as the input unit is photographed using the camera modules 211, 211 and 21n including the wide-angle lens having a viewing angle of 360 degrees as shown in FIG. 3A, the above-mentioned virtual input space may be formed not only in an upper surface just over a display of the display unit 401 but also in left and right spaces deviated from the upper space as shown in FIG. 3B.

The image sensor functions to convert light received through the lens into an electrical video signal. Then, the converted video signal is transmitted to the position determination unit 220 via the communication interface to be used to determine a motion pattern of the input unit.

The position determination unit 220 can perform a function of calculating a position of the input unit disposed on the virtual input space from an image of the input unit obtained by the camera modules 211, 211 and 21n, i.e., position coordinate values of the input unit.

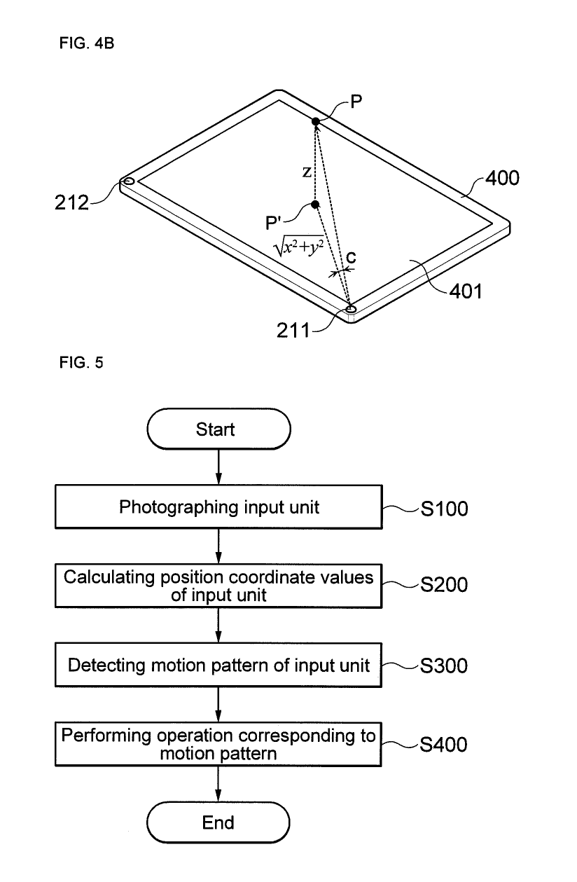

FIG. 4 is an explanatory view for understanding an operation performed by the position determination unit 220 included in the user interface device 100 according to the present invention, specifically describing the operation performed by the position determination unit 22 with reference to FIG. 4.

For example, provided that each of the camera modules is constituted by two cameras as shown in FIG. 2 and disposed on the same line along an edge of the display unit 401 around both ends of the display unit 401, respectively, a vertical point P′, at which the input unit disposed at one position on the virtual input space is perpendicular to a plane of the display unit, is obtained from the image of the input unit obtained by the camera modules 211 and 212.

In addition, as shown in FIG. 4A, an angle a formed by a straight line connecting the two camera modules 211 and 212 and a straight line connecting the first camera module 211 of the two camera modules and a vertical point P′ is obtained, an angle b formed by a straight line connecting the two camera modules 211 and 212 and a straight line connecting the second camera module 212 of the two camera modules and the vertical point P′ is obtained, and then, x and y coordinate values of the input unit is obtained using the angles a and b through trigonometry.

Further, as shown in FIG. 4B, a length \sqrt{x²+y²} of the straight line connecting the first camera module 211 and the vertical point P′ is obtained using the x and y coordinate values, an angle c formed by the input unit P disposed at one position on the virtual input space and a plane of the display unit 401, and then, a z-axis coordinate of the input unit is obtained through the trigonometry using the length \sqrt{x²+y²} and the angle c, finally obtaining position coordinate values on the virtual input space of the input unit.

The motion pattern determination unit 230 performs a function of detecting a motion pattern of the input unit based on the obtained coordinate values x, y and z of the input unit. For this purpose, the motion pattern determination unit 230 can receive the position coordinate values of the input unit from the position determination unit 220 in real time.

The control unit 300 generates a control signal to perform an operation corresponding to the motion pattern of the input unit, and functions as an interface, which is a physical or virtual medium connecting the electronic instrument and the user.

Here, a method of providing a user interface using the user interface device 100 according to the present invention will be described.

FIG. 5 is a flowchart sequentially shoeing the method of providing a user interface according to the present invention. The method of providing a user interface according to the present invention may first perform photographing an input unit that moves on a virtual input space formed around an electronic instrument main body 400 including a display unit 401 using a of camera modules 211, 211 and 21n (S100).

S100 may be performed by receiving the light reflected by the input unit through a wide-angle lens having a viewing angle of 360 degrees, and converting the received light into an electrical video signal.

Before S100, the method of providing a user interface according to the present invention may further include forming a virtual input space corresponding to a viewing angle that can be secure by the camera modules 211, 211 and 21n.

The user interface device 100 according to the present invention may be formed in not only an upper space just over a display of the display unit 401 but also in left and right spaces deviated from the upper space as the input unit is photographed using the camera modules 211, 211 and 21n including the wide-angle lenses having a viewing angle of 360 degrees.

Next, the input unit can perform calculating coordinate values of a position disposed on the virtual input space from the image of the input unit obtained by the camera modules 211, 211 and 21n.

As shown in FIG. 2, provided that each of the camera modules is constituted by two cameras disposed on the same line at both ends of the display unit 401, respectively, S200 performs obtaining a vertical point P′, at which the input unit disposed at one position on the virtual input space is perpendicular to a plane of a display unit, from the image of the input unit obtained by the camera modules 211 and 212.

Next, an angle a formed by a straight line connecting the two camera modules 211 and 212 and a straight line connecting the first camera module 211 and the vertical point P′ is calculated, an angle b formed by a straight line connecting the two camera modules 211 and 212 and a straight line connecting the second camera module 212 and the vertical point P′ is calculated, and then, x and y coordinate values of the input unit is obtained through a trigonometry using the angles a and b.

Next, a length \sqrt{x²+y²} of the straight line connecting the first camera module 211 and the vertical point P′ is obtained using the x and y coordinate values, an angle c formed by an input unit P disposed at one position on the virtual input space and the display unit 401 is calculated, and then, a z-axis coordinate value of the input unit is obtained through trigonometry using the length \sqrt{x²+y²} and the angle c, finally obtaining the coordinate values x, y and z of the position on the virtual input space of the input unit.

As described above, when the position coordinate values x, y and z of the input unit are calculated, the method of providing a user interface according to the present invention may perform detecting a motion pattern of the input unit based on the position coordinate values (S300).

Next, as performing an operation corresponding to the motion pattern of the input unit is performed (S400), the function of the interface, which is a physical or virtual medium connecting the electronic instrument main body 400 and the user, is performed.

As can be seen from the foregoing, according to the user interface device and the method of providing a user interface according to the present invention, as the user interface configured to detect movement on the virtual input space formed around the display, the user can more comfortably and intuitively control the electronic instrument system.

In addition, according to the user interface device and the method of providing a user interface according to the present invention, movement of the input unit on not only the upper space just over the display but also the left and right spaces deviated from the upper space can be detected to provide more convenient user interface environments.

Embodiments of the invention have been discussed above with reference to the accompanying drawings. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A user interface device comprising:
a motion detection unit configured to detect a motion pattern of an input unit that moves on a virtual input space formed around an electronic instrument main body including a display unit; and
a control unit configured to perform an operation corresponding to the motion pattern of the input unit,
wherein the motion detection unit comprises:
a plurality of camera modules installed around both sides of the display unit to photograph the input unit;
a position determination unit configured to calculate position coordinate values, at which the input unit is disposed on the virtual input space, from an image of the input unit obtained by the respective camera modules; and
a motion pattern determination unit configured to detect the motion pattern of the input unit based on the position coordinate values.

2. The user interface device according to claim 1, wherein the virtual input space is formed at an upper space of the display unit or left and right spaces of the upper space according to a viewing angle that can be obtained by the camera modules.

3. The user interface device according to claim 1, wherein each of the camera modules comprises:
a wide-angle lens having a viewing angle of 360 degrees;
an image sensor configured to convert light received through the lens into an electrical video signal; and
a communication interface in communication with the position determination unit.

4. The user interface device according to claim 1, wherein the number of camera modules is two.

5. The user interface device according to claim 4, wherein the two camera modules are disposed on the same line along an edge of the display unit.

6. The user interface device according to claim 5, wherein the position determination unit obtains a vertical point P′, at which the input unit disposed at one position on the virtual input space is perpendicular to a plane of the display unit, from the image of the input unit obtained by the camera modules,
calculates an angle a formed by a straight line connecting the two camera modules and a straight line connecting a first camera module of the two camera modules and the vertical point P′, calculates an angle b formed by a straight line connecting the two camera modules and a straight line connecting a second camera module of the two camera modules and the vertical point P′, and obtains x and y coordinate values of the input unit and a length of a straight line connecting the first camera module and the vertical point P′, and
calculates an angle c formed by the input unit and the plane of the display unit to obtain a z coordinate value of the input unit.

7. The user interface device according to claim 1, wherein the motion pattern determination unit receives the position coordinate values of the input unit from the position determination unit to detect the motion pattern.

8. A method of providing a user interface comprising:
photographing an input unit that moves on a virtual input space formed around an electronic instrument main body including a display unit using a plurality of camera modules;
calculating position coordinate values at which the input unit is disposed on the virtual input space from an image of the input unit obtained by the respective camera modules;
detecting a motion pattern of the input unit based on the position coordinate values; and
performing an operation corresponding to the motion pattern of the input unit.

9. The method of providing a user interface according to claim 8, further comprising, before photographing the input unit,
forming the virtual input space in the display unit or a region deviated from the display unit according to a viewing angle that can be obtained by the camera modules.

10. The method of providing a user interface according to claim 8, wherein photographing the input unit performs a process of receiving light reflected by the input unit through a wide-angle lens having a viewing angle of 360 degrees and converting the received light into an electrical video signal.

11. The method of providing a user interface according to claim 8, wherein calculating the position coordinate values comprises:
obtaining a vertical point P′ at which the input unit disposed at one position on the virtual input space is perpendicular to a plane of the display unit from an image of the input unit obtained by the camera modules;
calculating an angle a formed by a straight line connecting the two camera modules and a straight line connecting a first camera module of the two camera modules and a vertical point P′, calculating an angle b formed by a straight line connecting the two camera modules and a straight line connecting a second camera module of the two camera modules and the vertical point P′, and obtaining x and y coordinate values of the input unit and a length of a straight line connecting the first camera module and the vertical point P′; and
calculating an angle c formed by the input unit and a plane of the display unit to obtain a z coordinate value of the input unit.
